(19) United States
(12) Patent Application Publication
(10) Pub. No.: US 2014/0039834 A1
(43) Pub. Date: Feb. 6, 2014

(54) METHOD AND APPARATUS FOR MONITORING EQUIPMENT CONDITIONS

(71) Applicant: Hitachi Power Solutions Co., Ltd., Hitachi-shi (JP)

(72) Inventors: Hisae SHIBUYA, Tokyo (JP); Shunji MAEDA, Tokyo (JP)

(73) Assignee: Hitachi Power Solutions Co., Ltd., Hitachi-shi (JP)

(21) Appl. No.: 13/956,419

(22) Filed: Aug. 1, 2013

(30) Foreign Application Priority Data
Aug. 1, 2012 (JP) 2012-171156

(51) Int. Cl. G06F 11/22

(52) U.S. Cl. CPC G06F 11/22
USPC 702/183

(57) ABSTRACT

In case-based anomaly detection in equipment such as a plant, it is necessary to search entire learned data for partial data close to newly observed data. Which needs a long computation time. In order to solve this problem, there is provided a method, the learned data is clustered into clusters and the centers of the clusters as well as data pertaining to the clusters are stored in advance. Data close to newly observed data is selected from only the learned data pertaining to a cluster close to the newly observed data. Then, a normal model is created from the selected data and an anomaly measure is found whereas a threshold value is determined. Subsequently, an anomaly measure is found from the newly observed data and the created normal model. Then, this anomaly measure is compared with the threshold value in order to detect an anomaly of the equipment.

### CLAIM OF PRIORITY

The present application claims priority from Japanese Patent Application JP 2012-171156 filed on Aug. 1, 2012, the content of which is hereby incorporated by reference into this application.

### BACKGROUND

The present invention relates to an equipment-condition monitoring method for detecting an anomaly at an early time on the basis of multi-dimensional time-series data output from a plant or equipment (herein after, refer to equipment) and relates to an equipment-condition monitoring apparatus adopting the method.

A power company supplies regional-heating hot water generated by making use of typically heat dissipated by a gas turbine and supplies high-pressure steam or low-pressure steam to a factory. A petrochemical company operates a gas turbine or the like as power-supply equipment. In a variety of plants and various kinds of equipment which make use of a gas turbine as described above, preventive maintenance for detecting a problem of a plant or a problem of equipment is very important for suppressing damages to society to a minimum.

There are various kinds of equipment requiring the aforementioned preventive maintenance such as monitoring aging of batteries in use and battery lives. The equipment can be equipment at apparatus and component levels. The equipment includes not only a gas turbine and a steam turbine, but also a water wheel used in a hydraulic power generation station, an atomic reactor employed in a nuclear power generation station, a wind mill used in a wind power generation station, an engine of an airplane, a heavy-machinery engine, a railroad vehicle, a rail road, an escalator and an elevator, to mention a few.

Thus, a plurality of sensors are installed in the object equipment and the object plant. Each of the sensors is used in determining whether a signal detected by the sensor is an anomaly signal or a normal signal by comparison of the detected signal with a monitoring reference for the sensor. Patent Documents 1 and 2 which are the specifications of U.S. Pat. No. 6,952,662 and U.S. Pat. No. 6,975,962 respectively disclose methods for detecting an anomaly of an object which is mainly an engine. In accordance with the disclosed methods, past data such as time-series sensor signals is stored in a database in advance. Then, the degree of similarity between observed data and the past data, which is learned data, is computed by adoption of an original method. Subsequently, inferred values are computed by linear junction of data having a high degree of similarity. Finally, differences between the inferred values and the observed data are output.

In addition, Japanese Patent Laid-open No. 2011-70635-A is used as Patent Document 3 which discloses an anomaly detection method for detecting whether or not an anomaly exists on the basis of an anomaly measure computed by comparison with a model created from past normal data.

In accordance with the anomaly detection method, the normal model is created by adoption of a local subspace technique. Non-Patent Document 1: Stephen W. Wegerich; Nonparametric modeling of vibration signal features for equipment health monitoring, Aerospace Conference, 2003, Proceedings 2003, IEEE, Volume 7, Issue 2003, Page(s): 3113-3121.

### SUMMARY

In accordance with the methods described in Patent Documents 1 and 2, normal-time data is given as learned data and, if data not included in the learned data is observed, the observed data is detected as a symptom of an anomaly. Since the anomaly detection performance is much affected by the quality of the learned data, however, it is necessary to collect normal learned data accurately and comprehensively. If it is necessary to collect such learned data for equipment having a large number of normal states, the collection of the data entails an extremely large load to be borne. In addition, even if learned data having a high quality can be collected, due to a method entailing a heavy computation load, the amount of data that can be processed within a realistic computation time is small. As a result, there are many cases in which the comprehensiveness can no longer be assured. In accordance with the method described in Patent Document 3, normal-time data is stored in advance as learned data and a normal model is created by making use of pieces of data close to measured data. Thus, an anomaly can be detected with a high degree of sensitivity. Since entire learned data must be searched, however, the computation time is long.

In order to solve the problems described above, the present invention provides an equipment-condition monitoring method adopting a sensitive and fast anomaly detection technique and an equipment-condition monitoring apparatus adopting the equipment-condition monitoring method.

In order to solve the problems described above, the present invention provides an equipment-condition monitoring method including the steps of: extracting feature vectors from sensor signals output by a plurality of sensors installed in equipment; pre-accumulating the centers of clusters obtained by clustering the extracted feature vectors and feature vectors pertaining to the clusters as learned data; extracting feature vectors from new sensor signals output by the sensors installed in the equipment; selecting a cluster for feature vectors extracted from the new sensor signals from the clusters pre-accumulated as the learned data; selecting a predetermined number of feature vectors from the feature vectors pertaining to the cluster selected from the clusters pre-accumulated as the learned data in accordance with the feature vectors extracted from the new sensor signals; creating a normal model by making use of the predetermined number of selected feature vectors; computing an anomaly measure on the basis of newly observed feature vectors and the created normal model; and determining whether the condition of the equipment is abnormal or normal on the basis of the computed anomaly measure.

In addition, in order to solve the problems described above, the present invention provides an equipment condition monitoring method including: creating learned data on the basis of sensor signals output by a plurality of sensors installed in equipment or an apparatus and accumulating the learned data; and a process of identifying anomalies of sensor signals newly output by the sensors installed in the equipment or the apparatus. The process of creating and accumulating the learned data includes: extracting feature vectors from the sensor signals; clustering the extracted feature vectors; accumulating the centers of clusters obtained by clustering the extracted feature vectors and feature vectors pertaining to the clusters as the learned data; selecting one cluster or a plurality of clusters in accordance with the extracted feature vectors from the clusters accumulated as the learned data for each of the extracted feature vectors; selecting a predetermined number of feature vectors in accordance with the extracted feature vectors from feature vectors pertaining to the selected cluster and creating a normal model by making use of the predetermined number of selected feature vectors and pertaining to the selected cluster; computing an anomaly measure on the basis of feature vectors and the created normal model; and computing a threshold value on the basis of the computed anomaly measure. On the other hand, the process of identifying anomalies of the sensor signals has: extracting feature vectors from newly observed sensor signals; selecting one cluster or a plurality of clusters in accordance with the newly observed feature vectors from the clusters accumulated as the learned data; selecting a predetermined number of feature vectors in accordance with the newly observed feature vectors from feature vectors pertaining to the selected cluster and creating a normal model by making use of the predetermined number of selected feature vectors and pertaining to the selected cluster; computing an anomaly measure on the basis of newly observed feature vectors and the created normal model; and determining whether a sensor signal is abnormal or normal on the basis of the computed anomaly measure and a threshold value.

In addition, in order to solve the problems described above, the present invention provides an equipment-condition monitoring method including: creating learned data on the basis of sensor signals output by a plurality of sensors installed in equipment or an apparatus and accumulating the learned data; and identifying anomalies of sensor signals newly output by the sensors installed in the equipment or the apparatus. The process of creating and accumulating the learned data includes: classifying operating conditions of the equipment or the apparatus into modes on the basis of event signals output from the equipment or the apparatus; extracting feature vectors from the sensor signals; clustering the extracted feature vectors; accumulating the centers of clusters obtained by clustering the extracted feature vectors and feature vectors pertaining to the clusters as the learned data; selecting one cluster or a plurality of clusters in accordance with the extracted feature vectors from the clusters accumulated as the learned data for each of the extracted feature vectors; selecting a predetermined number of feature vectors in accordance with the extracted feature vectors from feature vectors pertaining to the selected cluster and creating a normal model by making use of the predetermined number of selected feature vectors and pertaining to the selected cluster; computing an anomaly measure on the basis of the extracted feature vectors and the created normal model; and computing a threshold value for each of the modes on the basis of the computed anomaly measure. On the other hand, the process of identifying anomalies of the sensor signals has: classifying operating conditions of the equipment or the apparatus into modes on the basis of event signals; extracting feature vectors from newly observed sensor signals; selecting one cluster or a plurality of clusters in accordance with newly observed feature vectors from the clusters accumulated as the learned data; selecting a predetermined number of feature vectors in accordance with the newly observed feature vectors from feature vectors pertaining to the selected cluster and creating a normal model by making use of the predetermined number of selected feature vectors and pertaining to the selected cluster; computing an anomaly measure on the basis of the newly observed feature vectors and the created normal model; and determining whether a sensor signal is abnormal or normal on the basis of the computed anomaly measure, the mode and a threshold value computed for the mode.

In addition, in order to solve the problems described above, the present invention provides an equipment-condition monitoring apparatus for monitoring the condition of equipment on the basis of sensor signals output by a plurality of sensors installed in the equipment. The equipment-condition monitoring apparatus includes: a raw-data accumulation section configured to accumulate the sensor signals output by the sensors installed in the equipment or the object apparatus; a feature-vector extraction section configured to extract feature vectors from the sensor signals; a clustering section configured to cluster the feature vectors extracted by the feature-vector extraction section; a learned-data accumulation section configured to accumulate the centers of clusters obtained as a result of the clustering carried out by the clustering section and feature vectors pertaining to the clusters as learned data; a cluster selection section configured to select a cluster in accordance with feature vectors extracted by the feature-vector extraction section from the learned data accumulated by the learned-data accumulation section; a normal-model creation section configured to select a predetermined number of feature vectors in accordance with feature vectors extracted by the feature-vector extraction section among feature vectors pertaining to a cluster selected by the cluster selection section and create a normal model by making use of the predetermined number of selected feature vectors; an anomaly-measure computation section configured to compute an anomaly measure on the basis of the predetermined number of feature vectors and the normal model created by the normal-model creation section; a threshold-value setting section configured to set a threshold value on the basis of an anomaly measure computed by the anomaly-measure computation section as an anomaly measure of a feature vector included in the learned data accumulated in the learned-data accumulation section; and an anomaly determination section configured to determine whether the condition of the equipment or the condition of the object apparatus is abnormal or normal by making use of the anomaly measure computed by the anomaly-measure computation section and the threshold value set by the threshold-value setting section.

In accordance with the present invention, in the determination of an anomaly of newly observed data, a normal model is created by making use of predetermined pieces of learned data and existing in close proximity to that of the observed data. Thus, the anomaly can be detected with a high degree of sensitivity. To put it in detail, the learned data is clustered in advance and a normal model is created by selecting predetermined pieces of data from data pertaining to a cluster selected in accordance with a newly observed feature vector. Thus, the data-piece count representing the number of pieces of data serving as a search object can be made small so that the computation time can be reduced substantially.

As described above, it is possible to implement a system capable of detecting an anomaly in various kinds of equipment and a variety of components with a high degree of sensitivity and a high speed by carrying out preventive maintenance such as monitoring aging of batteries in use and battery lives. The equipment can be equipment at apparatus and component levels. The equipment includes not only a gas turbine and a steam turbine, but also a water wheel used in a hydraulic power generation station, an atomic reactor employed in a nuclear power generation station, a wind mill used in a wind power generation station, an engine of an airplane, a heavy-machinery engine, a railroad vehicle, a rail road, an escalator and an elevator, to mention a few.

These features and advantages of the present invention will be apparent from the following more particular description of preferred embodiments provided by the invention as illustrated in the accompanying drawings.

### BRIEF DESCRIPTION OF THE DRAWINGS

FIG. 1 is a block diagram showing a rough configuration of an equipment-condition monitoring system according to an embodiment of the present invention;

FIG. 2 is a table showing a signal list of typical sensor signals in the embodiment of the present invention;

FIG. 3 is a flowchart representing processing starting with an operation to receive a sensor signal and ending with an operation to store learned data in the embodiment of the present invention;

FIG. 4 is a flowchart representing processing to determine an initial position of the center of a cluster in the embodiment of the present invention;

FIG. 5 is a flowchart representing clustering in the embodiment of the present invention;

FIG. 6 is a flowchart representing processing to re-divide clusters in the embodiment of the present invention;

FIG. 7 is a flowchart representing processing to adjust the number of members of a cluster in the embodiment of the present invention;

FIG. 8 is a flowchart representing processing to set a threshold value on the basis of an anomaly measure in the embodiment of the present invention;

FIG. 9 is an explanatory diagram to be referred to in description of a local subspace method;

FIG. 10 is a flowchart representing anomaly detection processing in the embodiment of the present invention;

FIG. 11A is a table showing a signal list of typical event signals in the embodiment of the present invention;

FIG. 11B is a flowchart representing mode classification processing based on an event signal in the embodiment of the present invention;

FIG. 11C is a model diagram of event signals showing conditions classified into four different modes by dividing a changeable state of equipment in the embodiment of the present invention;

FIG. 12 is a front-view diagram showing a display screen displaying an example of a GUI (Graphical User Interface) for setting a recipe in the embodiment of the present invention;

FIG. 13A is a front-view diagram showing a display screen displaying a sensor signal on a sensor-signal display window serving as an example of a GUI for displaying results of a test in the embodiment of the present invention;

FIG. 13B is a front-view diagram showing a display screen displaying a selected-cluster number on a sensor-signal display window serving as an example of a GUI for displaying results of a test in the embodiment of the present invention;

FIG. 13C is a front-view diagram showing a display screen displaying an enlarged screen serving as an example of a GUI for displaying results of a test in the embodiment of the present invention;

FIG. 13D is a front-view diagram showing a display screen displaying a cluster-information display screen serving as an example of a GUI for displaying results of a test in the embodiment of the present invention;

FIG. 14 is a front-view diagram showing a screen displaying a list of test results on an example of a result display screen in the embodiment of the present invention;

FIG. 15 is a front-view diagram showing a display screen displaying an example of a GUI for specifying a display object in the embodiment of the present invention;

FIG. 16A is a front-view diagram showing a display screen displaying all results on an example of a screen for displaying results of anomaly determination processing in the embodiment of the present invention; and

FIG. 16B is a front-view diagram showing a display screen displaying some enlarged results on a screen for displaying results of anomaly determination processing in the embodiment of the present invention.

### DESCRIPTION OF THE PREFERRED EMBODIMENTS

The present invention is an invention for solving a problem that the computation time is long due to the fact that it is necessary to search the entire learned data for data close to newly observed data in case-based anomaly detection in equipment of a plant or the like. Thus, the present invention provides a method and an apparatus. In the method and the apparatus, feature vectors are extracted from sensor signals output by a plurality of sensors installed in the equipment or an object apparatus. Then, the extracted feature vectors are clustered. Subsequently, the centers of clusters obtained as a result of the clustering and feature vectors pertaining to the clusters are accumulated in advance as the learned data. When newly observed data is received, data pertaining to a cluster close to the newly observed data is selected from the learned data. Then, a normal model is created from the selected data and an anomaly measure is computed. Subsequently, a threshold value is determined and an anomaly measure is computed from the newly observed data and the normal model. Then, the anomaly measure is compared with the threshold value in order to detect an anomaly of the equipment. By clustering and storing the learned data in advance and by creating a normal model through the use of the learned data pertaining to a cluster close to the newly observed data as described above, the time it takes to search for data can be shortened and an anomaly of the equipment can be diagnosed in a short period of time

The present invention is explained in detail by referring to diagrams as follows.

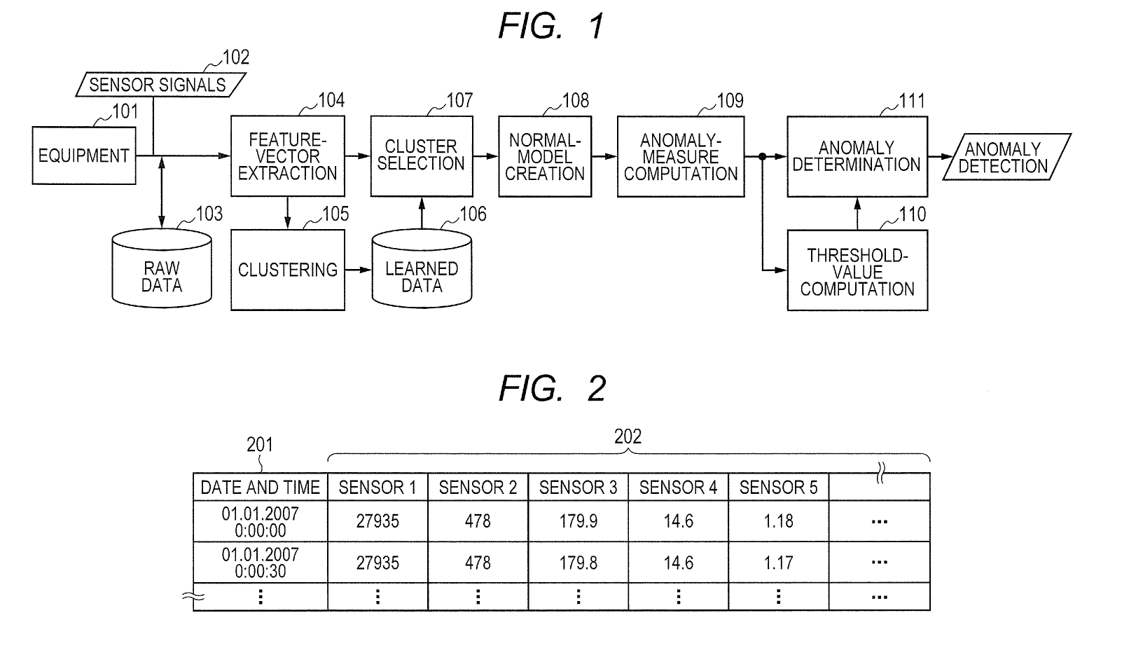

FIG. 1 is a diagram showing a typical configuration of a system for implementing an equipment-condition monitoring method according to the present invention.

As shown in the figure, the system includes a sensor-signal accumulation section 103, a feature-vector extraction section 104, a clustering section 105, a learned-data accumulation section 106, a cluster select section 107, a normal-model creation section 108, an anomaly-measure computation section 109, a threshold-value computation section 110 and an anomaly determination section 111. The sensor-signal accumulation section 103 is a section configured to accumulate sensor signals 102 output from equipment 101. The feature-vector extraction section 104 is a section configured to extract a feature vector on the basis of a sensor signal 102. The clustering section 105 is a section configured to cluster feature vectors. The learned-data accumulation section 106 is a section configured to accumulate learned data on the basis of a clustering result. The cluster select section 107 is a section configured to select a cluster close to newly observed data from the accumulated learned data. The normal-model creation section 108 is a section configured to search learned data pertaining to a selected cluster for as many pieces of data close to observed data as specified by a predetermined number and to create a normal model by making use of the pieces of data. The anomaly-measure computation section 109 is a section configured to compute an anomaly measure of newly observed data on the basis of the normal model. The threshold-value computation section 110 is a section configured to compute a threshold value on the basis of an anomaly measure of learned data. The anomaly determination section 111 is a section configured to determine whether newly observed data is normal or abnormal.

The operation of this system has two phases referred to as learning and anomaly detection. At the learning phase, learned data is created by making use of accumulated data and saved. At the anomaly-detection phase, on the other hand, an anomaly is actually detected on the basis of an input signal. Basically, the learning phase is offline processing whereas the anomaly-detection phase is online processing. However, the anomaly-detection phase can also be carried out as offline processing. In the following description, the technical term “learning process” is used to express the learning phase whereas the technical term “anomaly-detection process” is used to express the anomaly-detection phase.

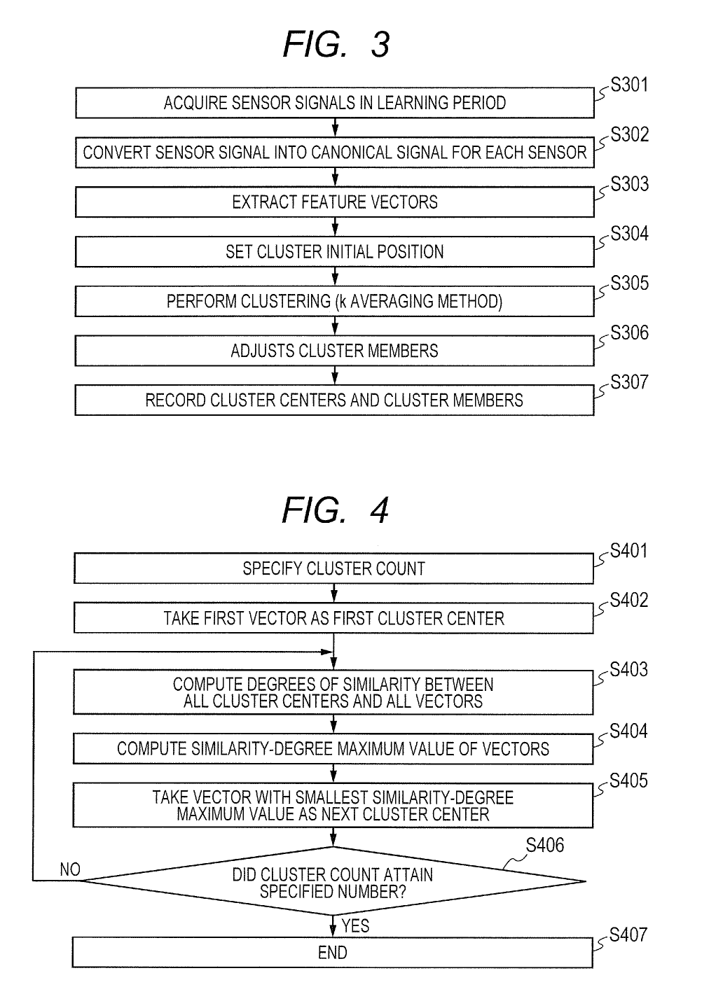

The equipment 101 serving as the object of condition monitoring represents equipment such as a gas turbine or a steam turbine and represents a plant. The equipment 101 outputs the sensor signal 102 representing the condition of the equipment 101. The sensor signal 102 is accumulated in the sensor-signal accumulation section 103. FIG. 2 is a table showing an example of a signal list of typical sensor signals 102. The sensor signal 102 is a multi-dimensional time-series signal acquired at fixed intervals. FIG. 2 shows the sensor signal 102 in a table format of a signal list. As shown in the figure, the table includes a date/time column 201 and a data column 202 showing data of signals output by a plurality of sensors installed in the equipment 101. The number of sensor types may be in a range of several hundreds to several thousands in some cases. For example, the sensors are sensors detecting the temperature of a cylinder, the temperature of oil, the temperature of cooling water, the pressure of oil, the pressure of cooling water, the rotational speed of a shaft, the room temperature and the length of an operating time, to mention a few. A sensor signal not only represents the output of the sensor or the sensor condition, but also serves a signal output in controlling a controlled quantity to a value represented by the signal.

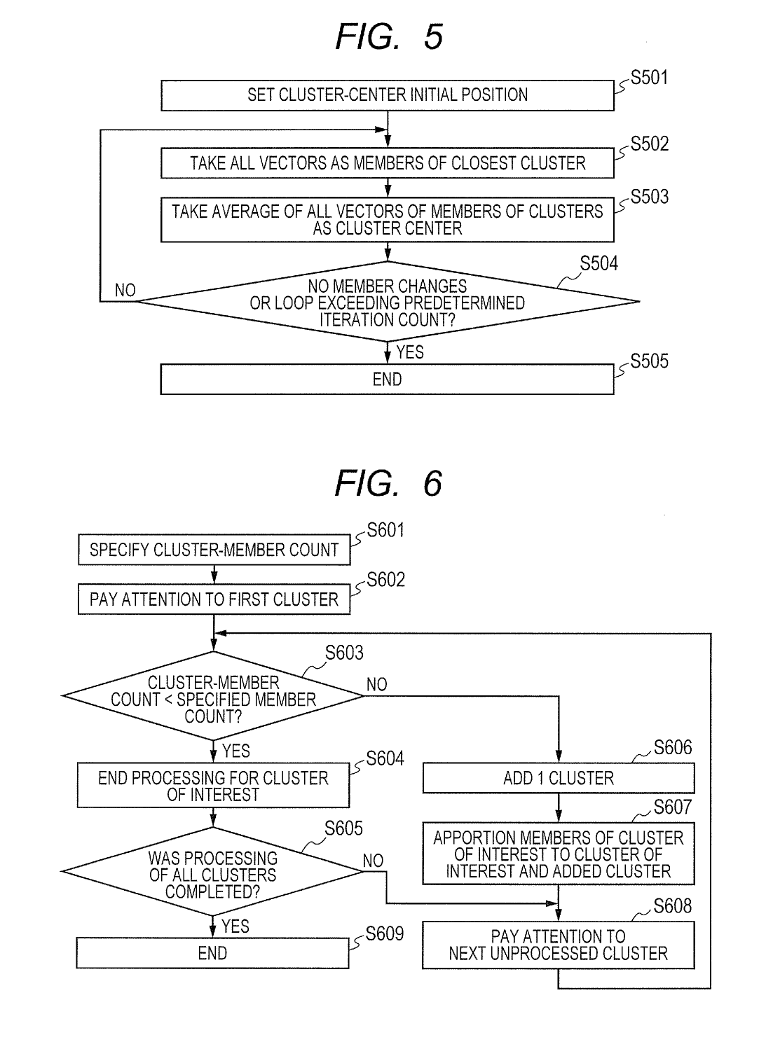

Next, the flow of a learning process is explained by referring to FIGS. 3 to 8 as follows. The learning process is carried out as follows. First of all, data of a specified period is selected from the data accumulated in the sensor-signal accumulation section 103. Then, the selected data is used for extracting feature vectors. Subsequently, the extracted feature vectors are clustered. Then, the centers of clusters and feature vectors pertaining to the clusters are accumulated as the learned data. In the following description, feature vectors pertaining to a cluster are referred to as cluster members. In addition, in the learning process, an anomaly measure of learned data is computed by adoption of a cross-validation and a threshold value of anomaly determination is calculated on the basis of anomaly measures of the entire learned data.

First of all, by referring to FIG. 3, the following description explains the flow of processing carried out by the feature-vector extraction section 104, the clustering section 105 and the learned-data accumulation section 106. As shown in the figure, the flow of the processing begins with step S301 at which the feature-vector extraction section 104 inputs a sensor signal 102 having a period specified as a learning period from the sensor-signal accumulation section 103. Then, at the next step S302, every sensor signal is carried out a canonicalization. Subsequently, at the next step S303, feature vectors are extracted. Then, at the next step S304, the clustering section 105 sets an initial position of the center of each cluster on the basis of the extracted feature vectors. Subsequently, at the next step S305, the clustering section 105 carries out clustering. Then, at the next step S306, the clustering section 105 adjusts the number of members in each cluster. Subsequently, at the next step S307, the learned-data accumulation section 106 stores the cluster centers and the cluster members.

Next, each of the steps described above is explained in detail as follows.

At step S302, every sensor signal is carried out a canonicalization. For example, on the basis of a specified period average and a standard deviation, every sensor signal is converted into a canonical signal to give an average of 0 and a variance of 1. The average of the sensor signals and the standard deviation of the sensor signals are stored in advance so that the same conversion can be carried out in the anomaly-detection process. As an alternative, by making use of maximum and minimum values of specified periods of the sensor signals, every sensor signal is converted into a canonical signal to give a maximum value of 1 and a minimum value of 0. As another alternative, in place of the maximum and minimum values, it is also possible to make use of upper and lower limits determined in advance. In the case of these alternatives, the maximum and minimum values of the sensor signals or the upper and lower limits of the sensor signals are stored in advance so that the same conversion can be carried out in the anomaly-detection process. In the conversion of the sensor signals into canonical ones, sensor signals having different units and different scales can be handled at the same time.

At step S303, a feature vector is extracted at each time. It is conceivable that sensor signals each completing the conversion into a canonical one are arranged as they are. However, for a certain time, a window of ±1, ±2, . . . and so on can be provided. Then, by making use of a product of a window width (3, 5, . . . and so on)×as many feature vectors as sensors, it is also possible to extract a feature representing a time change of the data. In addition, the DWT (Discrete Wavelet Transform) can also be carried out in order to disassemble a sensor signal into frequency components. In addition, at step S303, a feature is selected. As minimum processing, it is necessary to exclude a sensor signal having a very small variance and a monotonously increasing sensor signal.

In addition, it is conceivable that a signal invalidated by a correlation analysis is deleted by adoption of a method described as follows. If a correlation analysis carried out on a multi-dimensional time-series signal indicates very high similarity, that is, if the correlation analysis indicates that a plurality of signals having a correlation value close to 1 exist for example, the similar signals are considered to be redundant signals or the like. In this case, overlapping signals are deleted from the similar signals, leaving only remaining signals which do not overlap each other. As an alternative, the user may also specify signals to be deleted. In addition, it is conceivable that a feature with a large long-term variation is excluded. This is because the use of a feature with a large long-term variation tends to increase the number of normal conditions and gives rise of insufficient learned data. For example, it is possible to compute an average and a variance once a periodical interval and infer the magnitude of the long-term variation on the basis of changes of the average and the variance. In addition, at step S303, the number of signal dimensions can be reduced by adoption of any one of a variety of feature conversion techniques including a principal component analysis, an independent-component analysis, a non-negative matrix factorization, latency structure projection or a canonical correlation analysis, to mention a few.

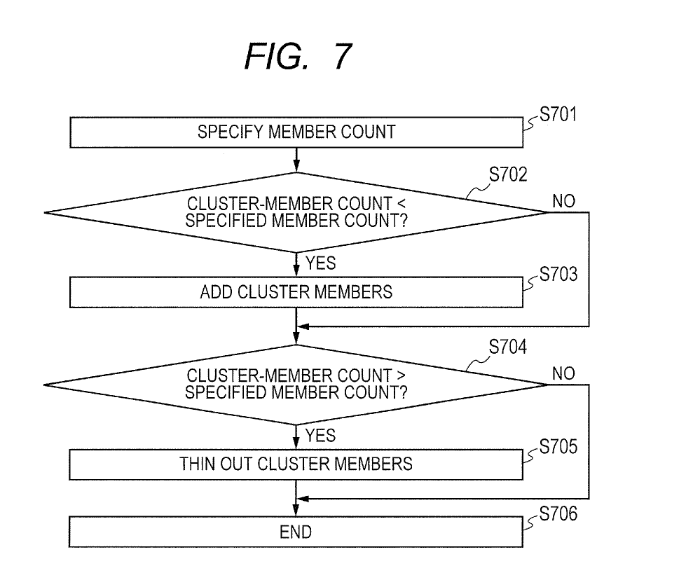

At step S304, an initial position of the center of each cluster is set. The flow of processing carried out at this step is explained by referring to FIG. 4 as follows. As shown in the figure, the processing begins with step S401 at which the number of clusters to be processed is specified. Then, at the next step S402, the first feature vector of a specified learning period is taken as the first cluster center. Subsequently, at the next step 5403, degrees of similarity between the already set cluster center and all feature vectors of the learning period are computed. Then, at the next step S404, a maximum value among the degrees of similarity between the already set cluster center and each feature vector of the learning period is computed. Subsequently, at the next step S405, a feature vector having the lowest maximum value of degree of similarity is taken as the next cluster center. The feature vector having the lowest degree of similarity is a feature vector having a longest distance to the closest cluster center. In the first iteration of the processing, the closest cluster center is the cluster center set at step S402. Then, if the result of the determination carried out at step S406 is YES indicating that the number of processed clusters has attained the number of clusters to be processed set at step S401, the flow of the processing goes on to step S407 at which the processing is ended. If the result of the determination carried out at step S406 is NO, on the other hand, the flow of the processing goes back to step S403 to repeat the operations of steps S403 to S406.

Generally, in many cases, in the first center position setting of the clustering, the first center position is set at random. Also in the present invention, the first center position can be set at random as well. In equipment with operation or termination changeovers, however, the amount of data in a transient state is smaller than the amount of data in a steady state. Thus, if the first center position is selected at random, data in a transient state is difficult to be selected. In this case, the effect of the data in a transient state on the computation of the cluster center unavoidably becomes relatively smaller. The method for setting an initial position of a cluster center as described above is provided to serve as a method for setting cluster-center initial positions which are separated from each other by a long distance. Thus, the number of transient-state clusters can be raised.

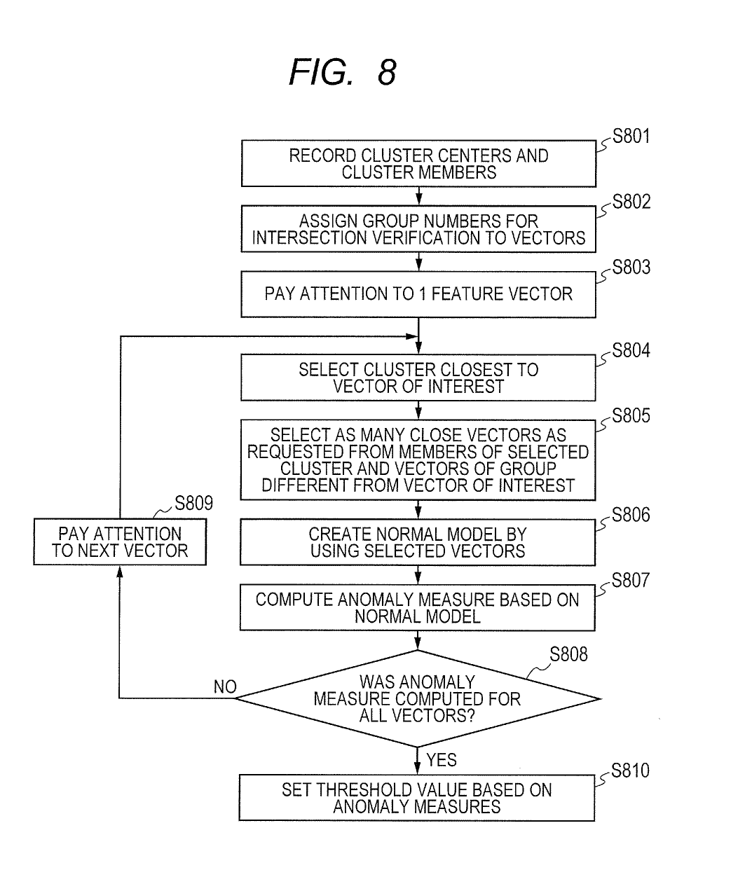

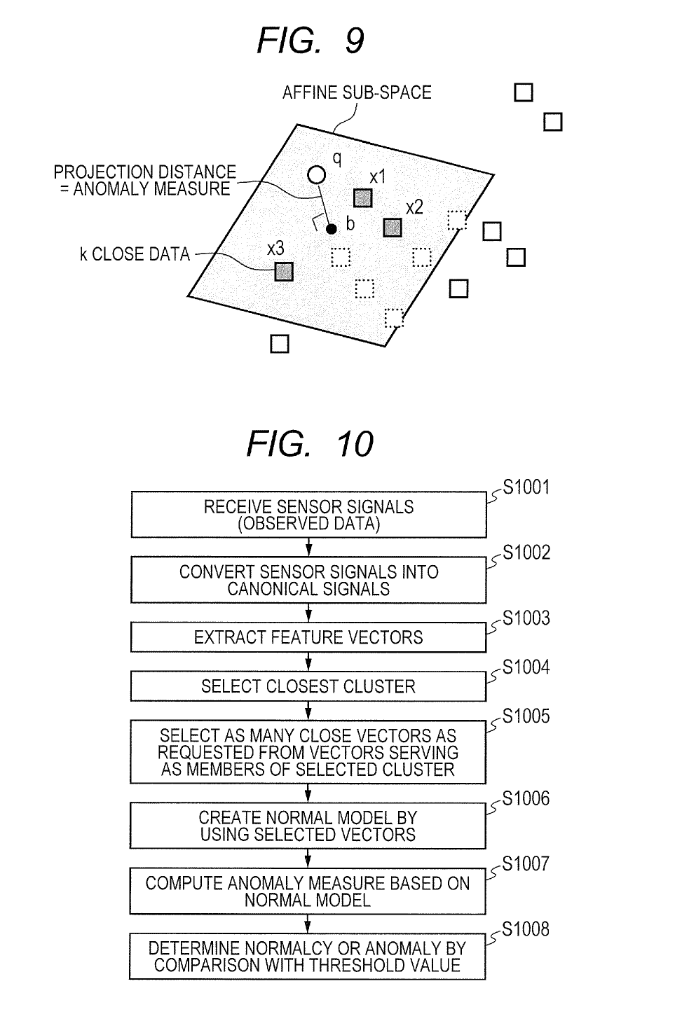

At step S305, clustering is carried out. Processing flows of the clustering are explained by referring to FIGS. 5 and 6 as follows. FIG. 5 is an explanatory diagram showing the flow of clustering carried out by adoption of a k averaging method. As described above, the initial position of the cluster center has been set at step S304 which is the first step S501 of the processing flow shown in FIG. 5. Then, at the next step S502, distances of all feature vectors in the specified period and cluster-center vectors are computed and the feature vectors are taken as a member of a closest cluster. Subsequently, at the next step S503, for each cluster, the average of feature vectors of all cluster members is taken as a new cluster-center vector. Then, the flow of the processing goes on to the next step S504 to determine whether or not members have changed for every cluster or whether or not the number of times to carry out the operations of steps S502 and S503 repeatedly has exceeded a number determined in advance. If the result of the determination carried out at step S504 is YES indicating that no members have changed for every cluster or the number of times to carry out the operations of steps S502 and S503 repeatedly has exceeded the number determined in advance, the flow of the processing goes on to step S505 at which the processing is ended. If the result of the determination carried out at step S504 is NO indicating that members have changed for every cluster or the number of times to carry out the operations of steps S502 and S503 repeatedly has not exceeded the number determined in advance, on the other hand, the flow of the processing goes back to step S502 to repeat the operations of steps S502 to S504.

FIG. 6 is an explanatory diagram showing the flow of processing carried out to divide a cluster obtained by performing the processing described above in order to reduce the number of members included in the cluster to a value not greater than a number determined in advance. However, execution of the processing shown in this figure is not mandatory. As shown in the figure, the flow of processing begins with step S601 at which the number of members included in a cluster is specified. Then, at the next step S602, attention is paid to the first cluster. Subsequently, at the next step S603 the number of members included in the cluster of interest is compared with the specified number of members in order to determine whether or not the number of members included in the cluster of interest is smaller than the specified number of members. If the result of the determination carried out at step S603 is YES indicating that the number of members included in the cluster of interest is smaller than the specified number of members, the flow of the processing goes on to step S604 at which the processing of the cluster of interest is ended. Then, the flow of the processing goes on to the next step S605 in order to determine whether or not all clusters have been processed. If the result of the determination carried out at step S605 is YES indicating that all clusters have been processed, the flow of the processing goes on to step S609 at which the processing is ended.

If the result of the determination carried out at step S603 is NO indicating that the number of members included in the cluster of interest is not smaller than the specified number of members, on the other hand, the flow of the processing goes on to step S606 at which one cluster is added. Then, at the next step S607, the members included in the cluster of interest are apportioned to the cluster of interest and the added cluster. To put it in detail, one feature vector is selected at random from members of the cluster of interest and used as the first center position of the cluster to be added. Then, the two clusters are created by adoption of the k averaging method explained before by referring to FIG. 5. After the operation of step S607 has been carried out, the flow of the processing goes on to the next step S608 at which attention is paid to an unprocessed cluster. Then, the flow of the processing goes back to step S603. If the result of the determination carried out at step S605 is NO indicating that not all clusters have been processed, on the other hand, the flow of the processing also goes on to step S608 at which attention is paid to an unprocessed cluster. Then, the flow of the processing goes back to step S603.

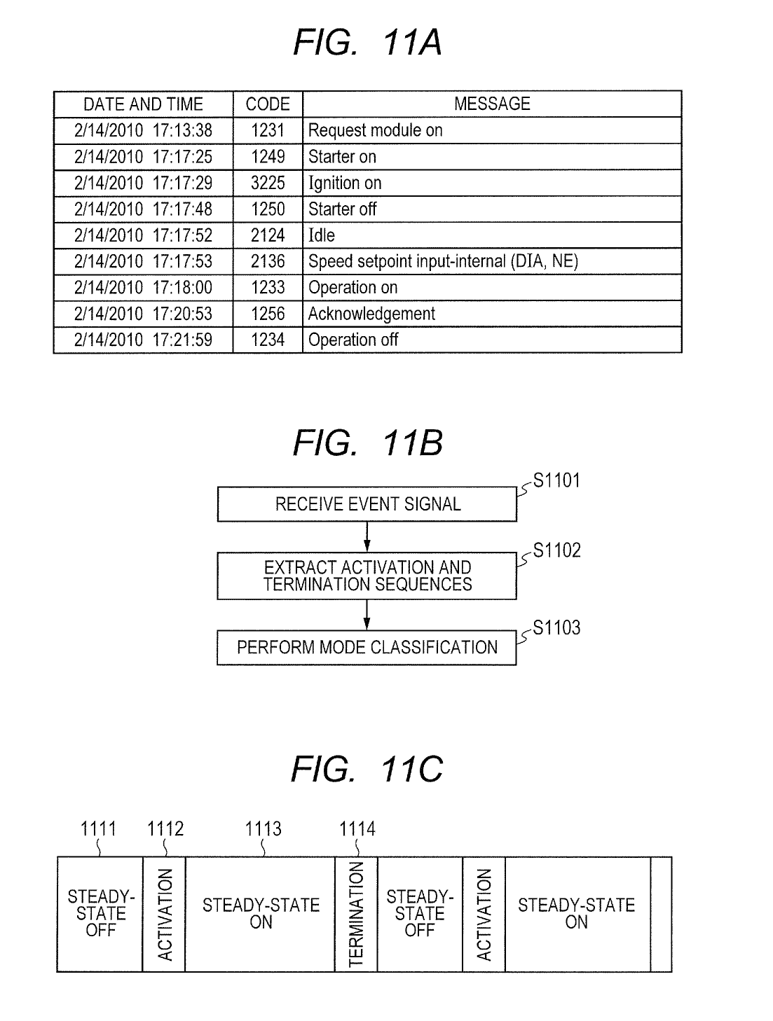

At step S306, adjustment is carried out to set the number of members included in a cluster at a fixed value. The processing flow of this adjustment is explained by referring to FIG. 7 as follows. As shown in the figure, the flow of the processing begins with step S701 at which the number of members included in a cluster is specified. If the processing represented by the flowchart shown in FIG. 6 has been carried out, the specified number of members is equal to that specified at step S601. Then, at the next step S702, the number of members actually included in a cluster is compared with the specified number of members in order to determine whether or not the number of members actually included in the cluster is smaller than the specified number of members. If the result of the determination carried out at step S702 is YES indicating that the number of members actually included in a cluster is smaller than the specified number of members, the flow of the processing goes on to step S703 at which members are added to the cluster so that the number of members actually included in the cluster becomes equal to the specified number of members. The members to be added to the cluster are selected from those existing outside the cluster and having feature vectors close to the center of the cluster in an increasing-distance order starting with a member closest to the center of the cluster. This operation prevents the number of search objects from becoming insufficient at a close-data search time in creation of a normal model. At the same time, with clusters overlapping each other, a proper close-data search can be carried out also for data close to boundaries of clusters.

If the result of the determination carried out at step S702 is NO indicating that the number of members actually included in a cluster is equal to or greater than the specified number of members, on the other hand, the flow of the processing goes on directly to step S704 by skipping step S703. At step S704, the number of members actually included in the cluster is compared with the specified number of members in order to determine whether or not the number of members actually included in the cluster is greater than the specified number of members. If the result of the determination carried out at step S704 is YES indicating that the number of members actually included in a cluster is greater than the specified number of members, the flow of the processing goes on to step S705 at which the cluster is thinned out by reducing the number of members actually included therein so that the number of actually included members becomes equal to the specified number of members. Then, at the next step S706, the processing is terminated. In the operation to thin out the cluster, members to be eliminated can be determined at random. A cluster having a great number of members indicates that the density of feature vectors in a feature space is high so that, even if some members determined at random are eliminated, no big difference is resulted in. This operation is carried out for the purpose of reducing the number of search objects used at a close-data search time in creation of a normal model so that the normal model can be created at a higher speed. If the result of the determination carried out at step S704 is NO indicating that the number of members actually included in a cluster is equal to or smaller than the specified number of members, on the other hand, the flow of the processing skips step S705, going on directly to step S706 at which the processing is terminated. The processing described above is carried out for every cluster. If the processing represented by the flowchart shown in FIG. 6 has been carried out in clustering, step S705 is always skipped. That is to say, the processing represented by the flowchart shown in FIG. 6 is carried out for the purpose of making results, which are obtained from a close-data search in a process of creating a normal model by eliminating members to be subjected to the thinning-out operation, close to results obtained by searching the entire learned data.

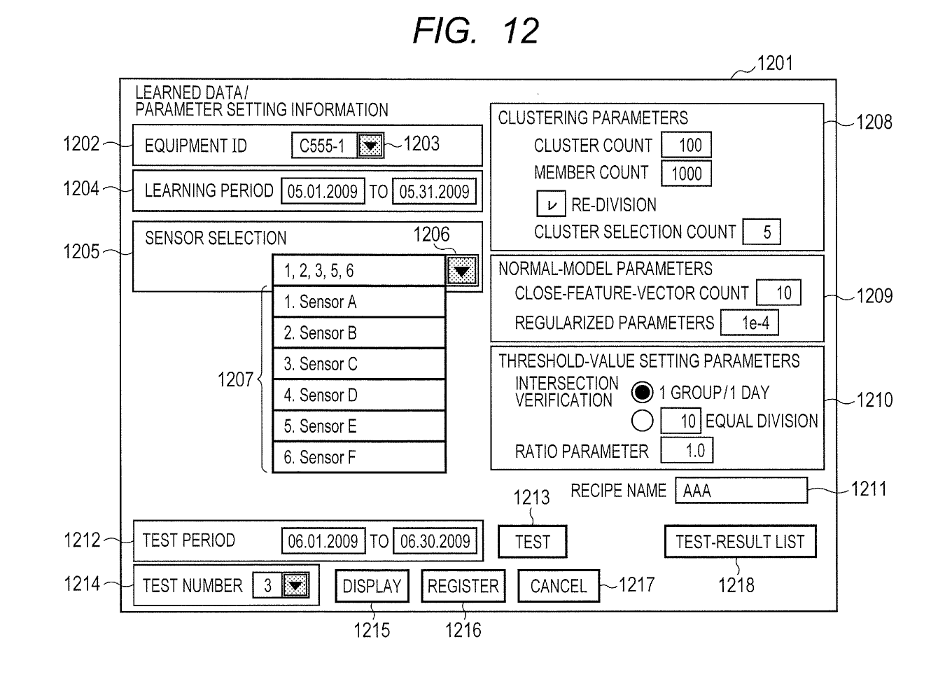

Next, by referring to FIG. 8, the following description explains the flow of processing carried out by the cluster select section 107, the normal-model creation section 108, the anomaly-measure computation section 109 and the threshold-value computation section 110. As shown in FIG. 8, the flow of the processing begins with step S801 at which the learned-data accumulation section 106 carries out the operation of step S307 of the flowchart shown in FIG. 3 in order to store the center of a cluster and members pertaining to the cluster. Then, at the next step S802, a group number for intersection verification is appended to every feature vector in a specified learning period. For example, a group may represent a period of one day. That is to say, a group is determined by specifying a period for the group. As an alternative, groups are determined by dividing a specified period into a plurality of equal sub-periods each represented by one of the groups. Then, at the next step S803, the cluster select section 107 pays attention to the first feature vector in a specified period. Subsequently, the flow of the processing goes on to the next step S804 to specify a cluster with the center thereof closest to the feature vector. In this case, there is also a conceivable method of selecting a plurality of clusters specified in advance in an increasing-distance order starting with a cluster having the center thereof closest to the feature vector.

Then, at the next step S805, the normal-model creation section 108 selects feature vectors the number of which has been specified in advance from feature vectors of a group different from the feature vector of interest in an increasing-distance order starting with a feature vector closest to the feature vector of interest. Each of the feature vectors is a member of a selected cluster. Then, at the next step S806, a normal model is created by making use of these feature vectors. Subsequently, at the next step S807, an anomaly measure is computed on the basis of a distance from the feature vector of interest to the normal model. Then, the flow of the processing goes on to the next step S808 to determine whether or not the anomaly-measure computation described above has been carried out for all feature vectors. If the result of the determination carried out at step S808 is YES indicating that the anomaly-measure computation described above has been carried out for all feature vectors, the flow of the processing goes on to step S810 at which the threshold-value computation section 110 sets a threshold value on the basis of the anomaly measures of all the feature vectors. If the result of the determination carried out at step S808 is NO indicating that the anomaly-measure computation described above has not been carried out for all feature vectors, on the other hand, the flow of the processing goes on to step S809 at which attention is paid to the next feature vector. Then, the flow of the processing goes back to step S804 in order to repeat the operations of steps S804 to S808.

Conceivable methods for creating a normal model include an LSC (Local Sub-space Classifier) and a PDM (Projection Distance Method).

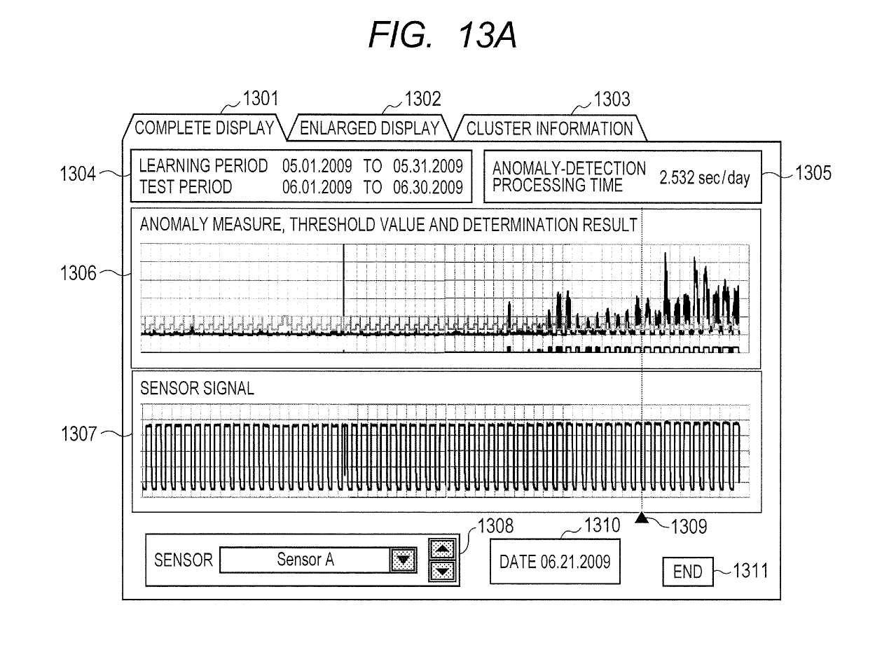

The LSC (Local Sub-space Classifier) is a method for creating a (k−1)-dimensional affine subspace by making use of k adjacent vectors close to an attention vector q. FIG. 9 shows an example for k=3. That is to say, the k adjacent vectors are feature vectors selected at step S805. The specified number is the value of k. As shown in FIG. 9, the anomaly measure is represented by a projection distance shown in the figure. Thus, it is sufficient to find a point b in the affine subspace closest to the interest drawing vector q.

In order to find the point b from the interest drawing vector q and the k adjacent vectors xi (i=1, . . . , k) close to the attention vector q, a correlation matrix C is found from a matrix Q obtained by arranging k attention vectors q and a matrix X obtained by arranging the adjacent vectors xi in accordance with Eq. (1) given as follows:

(1)

Then, the point b is found in accordance with Eq.

(2) given as follows:

(2)

The processing described so far is the normal model creation carried out at step S806.

Since the anomaly measure d is a distance between the interest drawing vector q and the point b, the anomaly measure d is expressed by the following equation:

(3)

As described above, a case for k=3 is explained by referring to FIG. 9. It is to be noted, however, that the value of k can be any value as long as the value of k is sufficiently smaller than the number of dimensions of the feature vector. The processing for k=1 is processing equivalent to the nearest neighbor method.

The projection distance method is a method for creating a subspace having an independent origin for a selected feature vector. That is to say, the projection distance method is a method for creating an affine subspace (or a variance maximum subspace). The feature-vector count specified at step S805 can have any value. If the feature-vector count representing the number of feature vectors is too large, however, it undesirably takes long time to select a feature vector and compute a subspace. Thus, a proper feature-vector count is a number in a range of several tens to several hundreds.

The method for computing an affine subspace is explained as follows. First of all, the average p of selected feature vectors and a covariance matrix E are computed. Then, an eigenvalue problem is solved to calculate r eigenvalues. The number r is a number determined in advance. Then, the r eigenvalues are arranged in a decreasing order starting with the largest one and a matrix U is created by arranging eigenvector for the r arranged eigenvalues. Subsequently, the matrix U is taken as the orthonormal base of the affine subspace. The number r is a number smaller than the number of dimensions of the feature vector and smaller than the selected-data count. As an alternative, instead of setting the number r at a fixed value, the number r may be set at a value which is obtained when a contribution ratio cumulated in a direction from the large one of the eigenvalues exceeds a ratio determined in advance. The anomaly measure is the distance of projection onto the affine subspace of the vector of interest.

As another method, it is possible to adopt a local average distance method, a Mahalanobis-Taguchi method, a Gaussian process method or the like. In accordance with the local average distance method, the distance to an average vectors of the k adjacent vectors close to the attention vector q is taken as the anomaly measure.

Next, the following description explains a method for setting a threshold value at step S810. First of all, a histogram is created. The histogram is a frequency distribution of the anomaly measure for all feature vectors. Then, a cumulative histogram is created on the basis of the frequency distribution and a value attaining a ratio close to 1 specified in advance is found. Subsequently, processing is carried out to compute a threshold value. The processing includes an operation to add an offset by taking this value as a reference in order to give a multiple. If the offset is 0 and the multiple is 1, the value is taken as the threshold value. The computed threshold value is saved by associating the threshold value with the learned data as shown in none of the figures.

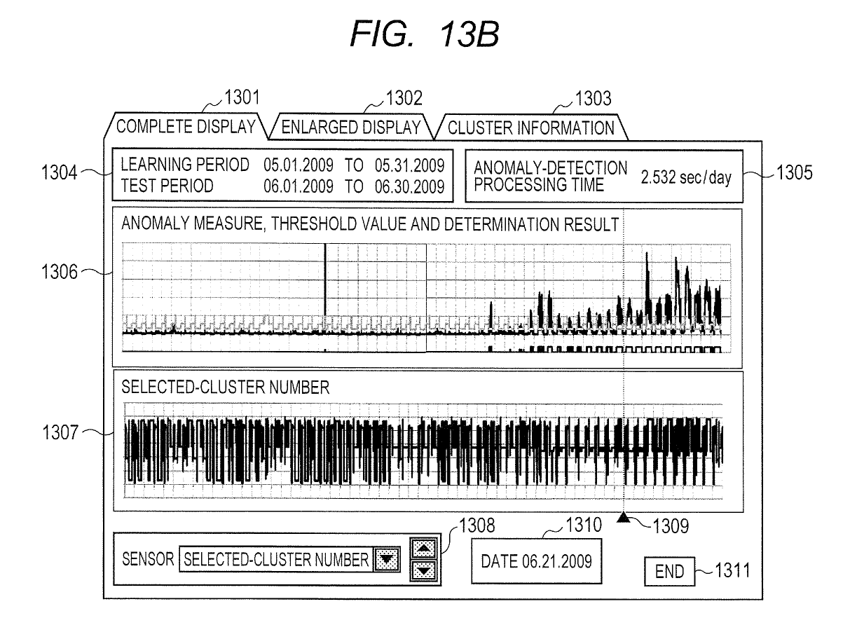

Next, the processing flow of the anomaly-detection process is explained by referring to FIG. 10. The anomaly-detection process is carried out to compute an anomaly measure of data in a specified period or an anomaly measure of newly observed data and make use of the anomaly measure in order determine whether the data in the specified period or the newly observed data is normal or abnormal. The data in the specified period is a portion of data accumulated in the sensor-signal accumulation section 103. As shown in the figure, the processing flow begins with step S1001 at which the feature-vector extraction section 104 inputs sensor signals from the sensor-signal accumulation section 103 or the equipment 101. Then, at the next step S1002, each sensor signal is converted into a canonical signal. Subsequently, at the next step S1003, a feature vector is extracted. The operation to convert a sensor signal into a canonical signal makes use of the same parameters as the operation carried out at step S302 of the flowchart shown in FIG. 3 to convert learned data into a canonical signal. In addition, the feature vector is extracted by adoption of the same method as the operation carried out at step S303 of the flowchart shown in FIG. 3 to extract a feature vector. Thus, if a characteristic has been selected at step S303, the same characteristic is selected at step S1003. If characteristic conversion such as the PCA has been carried out at step S303, on the other hand, conversion is carried out by making use of the same conversion formula at step S1003. In the following description, the extracted feature vector is referred to as an evaluation vector in order to differentiate the vector from the learned data.

Then, at the next step S1004, the cluster select section 107 selects a cluster having the cluster center closest to the evaluation vector from the centers of clusters and members of the clusters. As an alternative, the cluster select section 107 selects a plurality of clusters specified in advance in an increasing-distance order starting with the closest cluster. As described before, the cluster centers and the cluster members have been stored as learned data. Then, at the next step S1005, the normal-model creation section 108 selects a plurality of feature vectors, the number of which has been specified in advance, in an increasing-distance order starting with a feature vector closest to the evaluation vector, from feature vectors each serving as one of members of the selected cluster. Subsequently, at the next step S1006, the normal-model creation section 108 creates a normal model by making use of the selected feature vectors. Then, at the next step S1007, the anomaly-measure computation section 109 computes an anomaly measure on the basis of the distance from the evaluation vector to the normal model. Subsequently, at the next step S1008, the anomaly determination section 111 compares the anomaly measure with the threshold value computed in the learning process in order to determine whether the anomaly measure is normal or abnormal. That is to say, if the anomaly measure is greater than the threshold value, the anomaly measure is determined to be abnormal. Otherwise, the anomaly measure is determined to be normal.

The above description explains an embodiment of a method for detecting an anomaly on the basis of sensor signals output from equipment. Another embodiment described below implements another method for detecting an anomaly by making use of event signals output from the equipment. In accordance with this other embodiment, on the basis of the event signals, the operating conditions of the equipment are classified into modes each representing one of the operating conditions. In addition, the processing is carried out at step S810 to set a threshold value in accordance with the mode of the equipment. On top of that, the processing carried out at step S1008 to determine whether the anomaly measure is normal or abnormal makes use of a threshold value set for the mode.

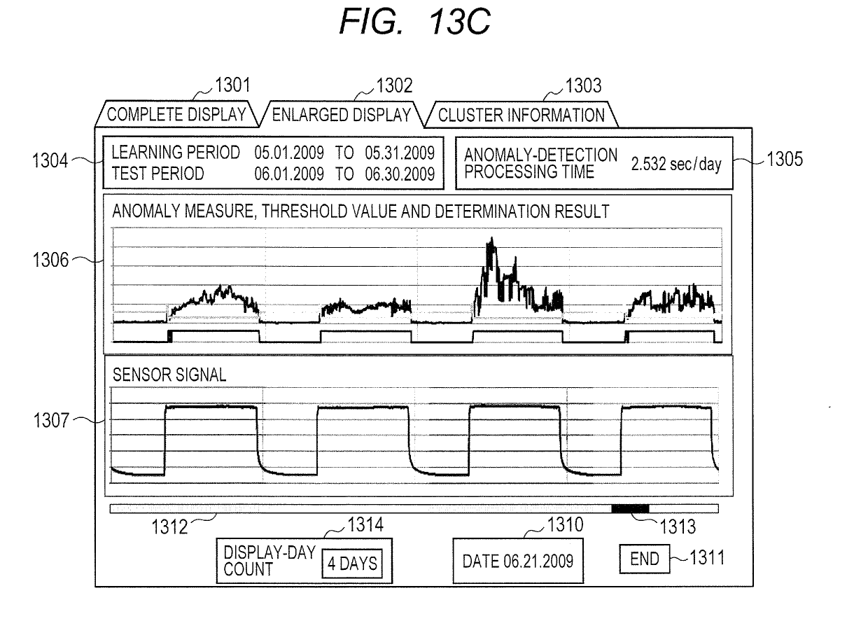

Except for the differences described above, the other method is entirely identical with the method explained before. Thus, by referring to FIGS. 11A to 11C, the following description explains only an embodiment implementing the method for classifying the operating conditions of the equipment into modes each representing one of the operating conditions on the basis of event signals. Examples of the event signals are shown in FIG. 11A. An event signal is a signal output by the equipment in an irregular manner to indicate an operation carried out by the equipment, a failure occurring in the equipment or a warning. The signal is a character string and/or a code which represent a time, the operation, the failure or the warning. FIG. 11B is a flowchart representing the mode classification processing based on an event signal. As shown in the figure, the flowchart begins with step S1101 at which an event signal is received. Then, at the next step S1102, by searching the event signal for a predetermined character string or a predetermined code, an activation sequence and a termination sequence are cut out. Subsequently, at the next step S1103, on the basis of the results of the operation carried out at step S1102, the condition of the equipment is divided into four operating conditions as shown in FIG. 11C. The four operating conditions are a steady-state off mode 1111, an activation mode 1112 in an activation sequence, a steady-state on mode 1113 and a termination mode 1114 in a termination sequence. The steady-state off mode 1111 starts at the end time of a termination sequence and ends at the start time of an activation sequence. On the other hand, the steady-state on mode 1113 starts at the end time of an activation sequence and ends at the start time of a termination sequence.

In order to cut out a sequence, the start event of the sequence and the end event of the sequence are specified in advance. Then, the sequence is cut out while scanning the event signal under the following conditions from the head of the event signal to the tail of the signal:

(1): In the case of the outside of a sequence, a start event is searched for. If a start event is found, the start event is taken as the start of the sequence.

(2): In the case of the inside of a sequence, an end event is searched for. If an end event is found, the end event is taken as the end of the sequence. The end events include not only a specified end event, but also a failure, a warning and a specified start event.

By making use of event information as described above, a variety of operating conditions can be identified with a high degree of accuracy. In addition, by setting a threshold value for every mode, an anomaly can be detected with a high degree of sensitivity in the steady-state off mode 1111 and the steady-state on mode 1113 even if it is necessary to lower the degree of sensitivity due to a lack of learning data in the activation mode 1112 and the termination mode 1114 which are each a transient-state mode.

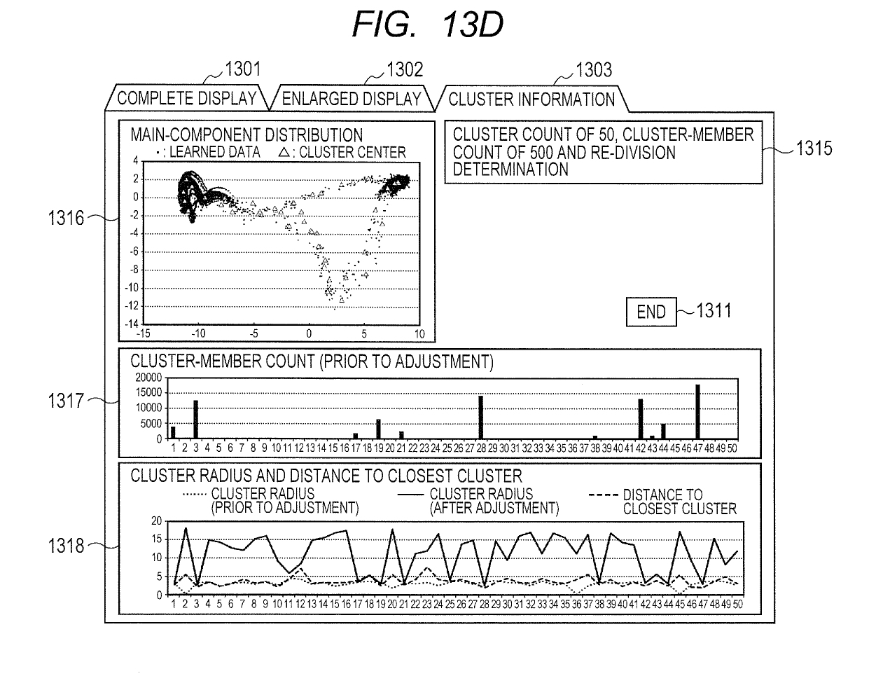

FIG. 12 is a diagram showing an example of a GUI for setting a learning period and processing parameters. In the following description, the operation to set processing parameters is referred to merely as recipe setting. In addition, past sensor signals 102 have been stored in a database by being associated with an equipment ID and a time. A recipe-setting screen 1201 is a screen for inputting information on an object apparatus, a learning period, used sensors, clustering parameters, normal-model parameters and threshold-value setting parameters. An equipment-ID input window 1202 is a window for inputting the ID of the object equipment. An equipment-list display button 1203 is a button to be pressed in order to display a list of equipment IDs of data. The list of equipment IDs has been stored in the database but has not been displayed on the screen. Thus, an equipment ID can be selected from the list. A learning-period input window 1204 is a window for inputting start and end dates of a learning period during which learned data is to be extracted. A sensor select window 1205 is a window for inputting the names of sensors to be used. A list display button 1206 is a button to be clicked in order to display a sensor list 1207. Thus, a sensor can be selected from the sensor list 1207. A plurality of sensors can also be selected from the sensor list 1207.

A clustering-parameter setting window 1208 is a window for inputting a cluster count specified in processing carried out by the clustering section 105 and the number of members included in every cluster. In addition, a check button is used to indicate whether or not the processing to re-divide a cluster as explained before by referring to FIG. 6 is to be carried out. On top of that, a cluster select count specified in processing carried out by the cluster select section 107 is input. A normal-model parameter input window 1209 is a window for inputting parameters specified in creation of a normal model. The figure shows an example of a case in which a local subspace is adopted as a normal model. In this example, a close-feature-vector count representing the number of close feature vectors to be used in creation of a normal model and regularized parameters are received. A regularized parameter is a small number to be added to a diagonal element in order to avoid a state in which the inverse matrix of the correlation matrix C cannot be computed in Eq. (2).

A threshold-value setting parameter input window 1210 is a window for specifying how the group of cross-validation in the processing explained before by referring to FIG. 8 is to be determined by making use of a radio button. To put it concretely, this window is used for specifying that one day is taken as one group or specifying that one day is divided into groups the number of which has been specified. In the latter case, the number of groups is also input. In addition, the value of a ratio applied to a cumulative histogram in the threshold-value setting operation carried out at step S810 is input. The value of this ratio is a ratio parameter. A recipe-name input window 1211 is a window for inputting a unique recipe name to be associated with the input information.

After all the information has been input, a test-period input window 1212 inputs a test-object period. Then, when a test button 1213 is pressed, a recipe test is carried out. By carrying out this operation, the sequence number of a test carried out under the same recipe name is taken. Then, the feature-vector extraction section 104 extracts feature vectors from sensor signals 102 in the specified learning period and the clustering section 105 clusters the feature vectors. Subsequently, the learned-data accumulation section 106 stores cluster centers and cluster members by associating with the recipe name and the test sequence number.

In the processing carried out at step S302 of the flowchart explained before by referring to FIG. 3 to convert sensor signals into canonical signals, an average and a standard deviation are computed for each sensor by making use of all data in the specified learning period. The computed values of the average and the standard deviation are stored in advance in the learned-data accumulation section 106 by associating the computed average and the standard deviation with the recipe name and the test sequence number for each sensor. By carrying out the processing explained before by referring to FIG. 8, an anomaly determination threshold value is computed and stored in the learned-data accumulation section 106 by associating the anomaly determination threshold value with the recipe name and the test sequence number. In addition, equipment-ID information, used-sensor information, the learning period, parameters used in the extraction of feature vectors, clustering parameters and normal-model parameters are stored in the learned-data accumulation section 106 by associating them with the recipe name and the test sequence number. Then, the sensor signals 102 generated in the specified test period are input and the anomaly-detection processing explained earlier by referring to FIG. 10 is carried out.

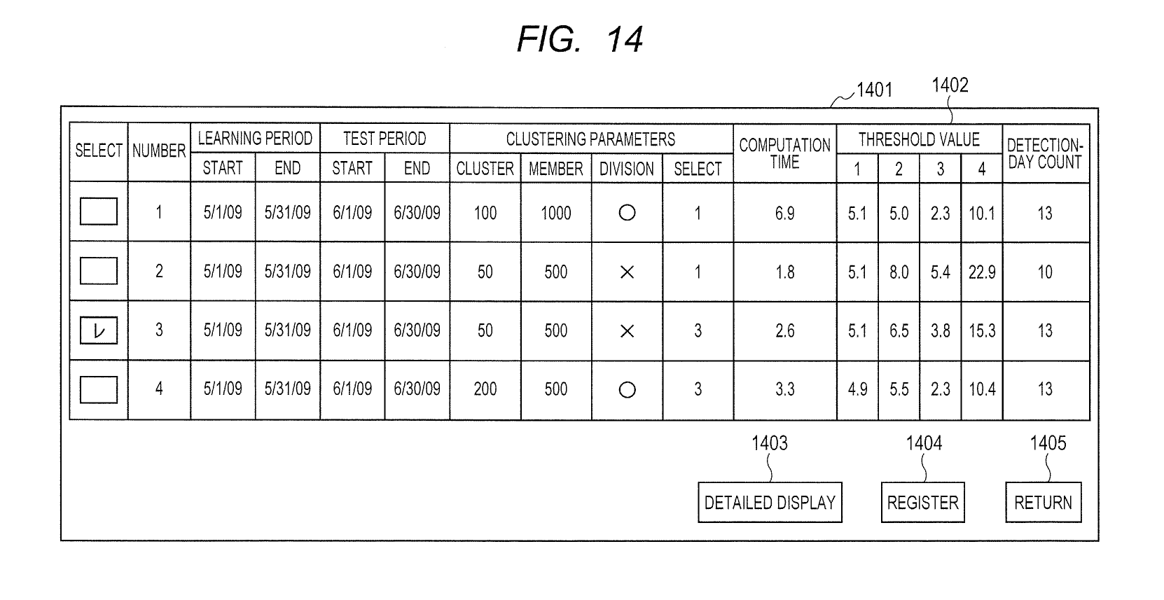

FIGS. 13A, 13B and 13C are diagrams showing typical GUIs for showing test results to the user. By selecting one of tabs shown on the upper portion of each screen, an all-result display screen 1301, a result enlarged-display screen 1302 or a cluster-information display screen 1303 can be displayed.

FIG. 13A is a diagram showing the all-result display screen 1301. The all-result display screen 1301 displays time-series graphs representing the anomaly measure, the threshold value, the determination result and the sensor signal throughout the specified entire period. A period display window 1304 displays the specified learning period and the specified test period whereas a processing-time display window 1305 displays the time it takes to carry out the processing to detect an anomaly. That is to say, the processing-time display window 1305 displays the time it takes to carry out the processing explained earlier by referring to FIG. 10. In the example shown in the figure, a processing time of one day is displayed. However, the processing time of the entire period or the processing time of one hour can also be displayed. An anomaly-measure display window 1306 displays the anomaly measure, the threshold value and the determination result for the specified learning period and the specified test period. A sensor-signal display window 1307 displays a signal output by a specified sensor in the specified period.

A sensor is specified by entering an input to a sensor-name select window 1308. Before the user specifies a sensor, however, the first sensor has been selected as a default. A cursor 1309 indicates the origin point of an enlarged display. The cursor 1309 can be moved by operating a mouse. The date of the position of the cursor 1309 is displayed on a date display window 1310. When an end button 1311 is pressed, the all-result display screen 1301, the result enlarged-display screen 1302 and the cluster-information display screen 1303 are erased to finish the display.

By making use of the sensor-name select window 1308, a cluster select number can also be selected. FIG. 13B is a diagram showing an example in which a cluster select number is displayed on the sensor-signal display window 1307. In the figure, the vertical axis of the graph represents the cluster number.

FIG. 13C is a diagram showing the result enlarged-display screen 1302. The result enlarged-display screen 1302 displays time-series graphs representing the anomaly measure, the threshold value, the determination result and the sensor signal for a period of days, the number of which has been specified. In this case, the date indicated by the cursor 1309 on the all-result display screen 1301 explained earlier by referring to FIG. 13A is taken as an origin point. The period display window 1304 and the processing-time display window 1305 display the same information as the all-result display screen 1301 explained in FIG. 13A. The anomaly-measure display window 1306 and the sensor-signal display window 1307 display the same information which are shown on the all-result display screen 1301 explained in FIG. 13A. However, the displays of the anomaly-measure display window 1306 and the sensor-signal display window 1307 which are shown on the result enlarged-display screen 1302 are enlarged. The date display window 1310 displays the date of the origin point of the enlarged displays. An enlarged-display day-count specification window 1314 is used for specifying the number of days between the origin and end points of the enlarged displays. A scroll bar 1313 is used for changing the origin point of the displays. This change is reflected in the position of the cursor 1309 in the all-result display screen 1301 and the display of the date display window 1310. The length of the entire scroll-bar display area 1312 corresponds to the entire period displayed on the all-result display screen 1301. In addition, the length of the scroll bar 1313 corresponds to a day count specified by making use of the enlarged-display day-count specification window 1314 whereas the left end of the scroll bar 1313 corresponds to the origin point of the enlarged displays. When the end button 1311 is pressed, the operation carried out by making use of result enlarged-display screen 1302 is terminated.

FIG. 13D is a diagram showing an example of the cluster-information display screen 1303. The cluster-information display screen 1303 displays a cluster distribution, the number of pre-adjustment cluster members, the radius of each of the pre- and post-adjustment cluster and a distance to the closest cluster. A clustering-parameter display window 1315 displays the cluster count and a cluster-member count as well as determination of whether or not re-division is to be carried out which are input by the clustering-parameter setting window 1208 explained earlier by referring to FIG. 12.

A cluster-distribution display window 1316 displays learned data and each cluster center which are plotted on a scattering diagram of first and second main components. In the example shown in the figure, the learned data is represented by dots whereas the cluster centers are each represented by a triangle. By making use of these graphs, it is possible to check whether or not the clusters are scattered everywhere all over the entire learned data. If few cluster centers exist in a portion having a low data density, it is possible to determine that the number of clusters is not sufficient. In addition, test data can be displayed by superposing the test data on the existing ones. On top of that, even though this example displays two-dimensional main components, a three-dimensional display is also possible. Furthermore, it is possible to adopt a method whereby any two or three sensors are selected in order to plot the learned data and each cluster center so as to show distributions of learned data and each cluster center in a feature space.

A cluster-member count display window 1317 displays cluster-member counts prior to the member-count adjustment processing explained before by referring to FIG. 7 as bar graphs. The horizontal axis of the graphs represents the cluster number whereas the vertical axis of the graphs represents the cluster-member count which is the number of members pertaining to a cluster. By making use of these graphs, a bias of the cluster-member counts can be checked. In the case of a cluster having a very large cluster-member count, increasing the number of clusters or carrying out the cluster re-division processing explained earlier by referring to FIG. 6 is attempted. A cluster-radius display window 1318 displays distances from the cluster centers before and after the adjustment of the cluster-member count to the farthest cluster member and distances to other closest cluster centers as polygonal-line graphs. The horizontal axis of the graphs represents the cluster number whereas the vertical axis of the graphs represents the distances. Before and after the adjustment of the cluster-member count, the radius of a cluster having a large original cluster-member count decreases whereas the radius of a cluster having a small original cluster-member count increases. If the cluster radius after the adjustment is greater than the distance to the closest cluster center, the end button 1311 is pressed to terminate the processing. Information required for the displays described above is stored in advance by associating the information with the name of the recipe and the number of the test.

When the end button 1311 on any one of the displays shown in FIGS. 13A to 13D is pressed in order to terminate the verification of the test results and the cluster information, the screen is restored to the display on the recipe setting screen 1201 shown in FIG. 12. A test-number display window 1214 displays the number of the test. If the verified test results and the verified cluster information have a problem, the clustering parameters are changed and, then, the test button 1213 is pressed in order to carry out the test again. As an alternative, the results of the test carried out once can also be verified again. A test number is selected from the test-number display window 1214 and supplied to the test-number display window 1214 and, then, a display button 1215 is pressed. By carrying out these operations, stored information associated with the name of the recipe and the number of the test is loaded and displayed on the all-result display screen 1301. By switching the tab from one to another, the result enlarged-display screen 1302 or the cluster-information display screen 1303 can also be displayed. When the verification is finished, the end button 1311 is pressed in order to return the display to the one shown on the recipe setting screen 1201.

A register button 1216 is pressed in order to register the information by associating the information with the name of the recipe and terminate the operations. The information has been stored in advance by associating the information with the name of the recipe and a test number displayed on the test-number display window 1214. If a cancel button 1217 is pressed, the operations are terminated by storing nothing.

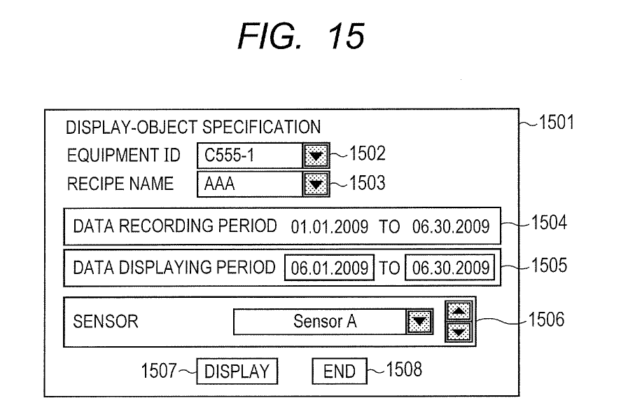

In addition, if a test-result list button 1218 is pressed, a test-result list display screen 1401 shown in FIG. 14 is displayed. A test-result list 1402 shows information for all tests. The displayed information is a test-result information which includes a learning period, a test period and recipe information including clustering parameters, a computation time, a threshold value and an anomaly-detection day count. At the left end of the test-result list 1402, select check buttons are provided. Only one of the select check buttons can be selected. If a detail display button 1403 is pressed, information stored by associating the information with the name of the recipe and the number of the test is loaded and the all-result display screen 1301 is displayed.

In the example shown in FIG. 14, a check mark has been put on the third select check button. Thus, when the detail display button 1403 is pressed, information stored by associating the information with a test number of 3 is displayed on the all-result display screen 1301 shown in FIG. 13A. By switching the tab from one to another, the result enlarged-display screen 1302 or the cluster-information display screen 1303 can also be displayed. When the verification has been completed, pressing the end button 1311 will restore the screen to the display of the test-result list display screen 1401. If a register button 1404 is pressed, information stored by associating with the selected test number is registered by associating with the name of the recipe and the display of the test-result list display screen 1401 as well as the display of the recipe setting screen 1201 are terminated. If a return button 1405 is pressed, the recipe setting screen 1201 is displayed without registering the recipe.

Registered recipes are managed by attaching a label to each of the recipes to indicate that the recipe is active or inactive. For newly observed data, by making use of information of an active recipe with a matching apparatus ID, processing from the step S1003 to the step S1008 is carried out and results of the processing are stored in advance by associating the results with the name of the recipe. As described before by referring to FIG. 10, the operation carried out at step S1003 is feature-vector extraction whereas the operation carried out at step S1008 is anomaly determination.

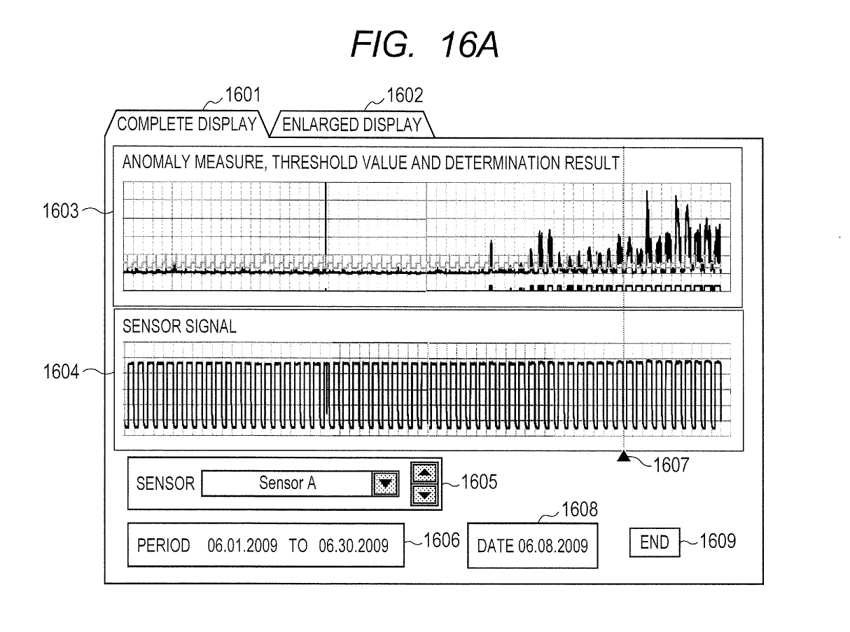

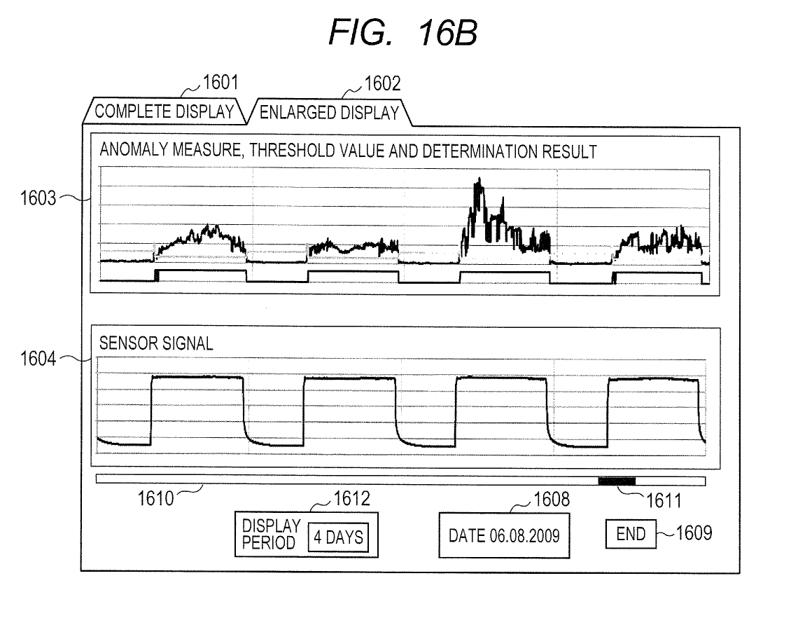

Next, by referring to FIGS. 15, 16A and 16B, the following description explains an example of a GUI for showing results of anomaly determination processing carried out by the feature-vector extraction section 104 to the user.

FIG. 15 is a diagram for showing an example of a GUI for specifying a display object. A display-object specification screen 1501 is used for specifying equipment, a recipe and a period which serve as a display object. First of all, an apparatus-ID select window 1502 is used for selecting an apparatus ID. Then, a recipe-name select window 1503 is used for selecting a recipe to serve as a display object from a list of recipes having the apparatus ID as its object. A data recording period display section 1504 displays start and end dates of a period during which data from processing carried out by making use of the selected recipe is recorded. A result display period specification window 1505 inputs start and end dates of a period during which results are to be displayed. A displayed-sensor specification window 1506 inputs the name of a sensor, a signal from which is to be displayed. When a display button 1507 is pressed, a result display screen 1601 shown in FIG. 16A is displayed. When an end button 1508 is pressed, the operations carried on this GUI are ended.

FIGS. 16A and 16B are each a diagram showing a GUI related to a display of results. By selecting one of tabs shown on the upper portion of each screen, a result display screen 1601 or a result enlarged-display screen 1602 can be displayed. FIG. 16A is a diagram showing the result display screen 1601. As shown in the figure, the result display screen 1601 includes an anomaly-measure display window 1603 and a sensor-signal display window 1604. The anomaly-measure display window 1603 displays an anomaly measure, a threshold value and a determination result for a specified period. On the other hand, the sensor-signal display window 1604 displays the value of a signal output by a specified sensor in a specified period. A sensor-name display window 1605 displays the name of a sensor, the signal of which is displayed on the sensor-signal display window 1604. By entering the name of a sensor to the sensor-name display window 1605, the sensor serving as a display object can be switched from one to another. A period display window 1606 displays a period serving as a display object. A cursor 1607 represents an origin point at an enlarged-display time. The cursor 1607 can be moved by operating a mouse. A date display window 1608 displays a date of the position of the cursor 1607. When an end button 1609 is pressed, the result display screen 1601 or the result enlarged-display screen 1602 is erased to end the operations carried out by making use of the result display screen 1601 or the result enlarged-display screen 1602 respectively.

FIG. 16B is a diagram showing the result enlarged-display screen 1602. As shown in the figure, the result enlarged-display screen 1602 includes an anomaly-measure display window 1603 and a sensor-signal display window 1604. Each of the anomaly-measure display window 1603 and the sensor-signal display window 1604 shows an enlarged display of information of the same type as the result display screen 1601. The displayed information has a time indicated by the cursor 1607 on the result display screen 1601 as an origin point. The date display window 1608 shows the date of the origin point of the enlarged displays. An enlarged display period specification window 1612 is used for specifying a period between the origin and end points of the enlarged displays in terms of days. The origin point of the display can be changed by making use of a scroll bar 1611. The change of the origin point is reflected in the position of the cursor 1607 and the display of the date display window 1608. The length of an entire scroll-bar display area 1610 corresponds to the length of an entire period displayed on the result display screen 1601. In addition, the length of the scroll bar 1611 corresponds to a period specified by making use of an enlarged display period specification window 1612 whereas the left end of the scroll bar 1611 corresponds to the origin point of the enlarged displays. The date display window 1608 displays the same information as the date display window 1608 of the result display screen 1601. When an end button 1609 is pressed, the result enlarged-display screen 1602 is erased to end the operations carried out by making use of the result enlarged-display screen 1602.

In the embodiments described above, learned data is set in an off-line manner, the anomaly detection processing is carried out in a real-time manner and results are displayed in an off-line manner. However, the results can also be displayed in a real-time manner. In this case, it is sufficient to provide a configuration in which the length of the display period, the recipe to serve as a display object and information to serve as a display object are determined in advance and most recent information thereon may be displayed at fixed intervals.

Conversely, the scope of the present invention includes a configuration having additional functions to set an arbitrary period, select an arbitrary recipe and carry out anomaly determination processing in an off-line manner.

The embodiments described above are merely implementations of the present invention and, thus, the present invention is by no means limited to the embodiments. That is to say, the scope of the present invention also includes a configuration in which some of the steps explained in the embodiment are replaced by steps (or means) having equivalent functions and a configuration in which some non-essential functions are eliminated.

The present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description, and all changes which come within the meanings and range of equivalency of the claims are therefore intended to be embraced therein.

What is claimed is:

1. A method for monitoring a condition of equipment, comprising the steps of:
extracting feature vectors from sensor signals output from a plurality of sensors installed in said equipment;
clustering said extracted feature vectors;
accumulating centers of clusters obtained by said clustering and feature vectors pertaining to said clusters as learned data;
extracting feature vectors from new sensor signals output from said sensors installed in said equipment;
selecting a cluster for feature vectors extracted from said new sensor signals from said clusters accumulated as said learned data;
selecting a predetermined number of feature vectors from said feature vectors pertaining to said cluster selected from said clusters accumulated as said learned data in accordance with said feature vectors extracted from said new sensor signals;
creating a normal model by making use of said predetermined number of selected feature vectors;
computing an anomaly measure on the basis of newly observed feature vectors and said created normal model; and
determining whether said condition of said equipment is abnormal or normal on the basis of said computed anomaly measure.

2. A method for monitoring a condition of equipment, comprising the steps of:
creating learned data on the basis of sensor signals output from a plurality of sensors installed in said equipment and accumulating said learned data; and
identifying anomalies of sensor signals newly output from said sensors installed in said equipment, wherein:
said creating and accumulating said learned data including the sub-steps of:
extracting feature vectors from said sensor signals;
clustering said extracted feature vectors;
accumulating the centers of clusters obtained by clustering said extracted feature vectors and feature vectors pertaining to said clusters as said learned data;
selecting one cluster or a plurality of clusters in accordance with said extracted feature vectors from said clusters accumulated as said learned data for each of said extracted feature vectors;
selecting a predetermined number of feature vectors in accordance with said extracted feature vectors from feature vectors pertaining to said selected cluster and creating a normal model by making use of said predetermined number of selected feature vectors and pertaining to said selected cluster;
computing an anomaly measure on the basis of said extracted feature vectors and said created normal model; and
computing a threshold value on the basis of said computed anomaly measure; and wherein:
said identifying anomalies of said sensor signals including the sub-steps of:
extracting feature vectors from newly observed sensor signals;
selecting one cluster or a plurality of clusters in accordance with newly observed feature vectors from said clusters accumulated as said learned data;
selecting a predetermined number of feature vectors in accordance with said newly observed feature vectors from feature vectors pertaining to said selected cluster and creating a normal model by making use of said predetermined number of selected feature vectors and pertaining to said selected cluster;
computing an anomaly measure on the basis of newly observed feature vectors and said created normal model; and
determining whether a sensor signal is abnormal or normal on the basis of said computed anomaly measure and said threshold value.

3. The method for monitoring the condition of equipment according to claim 2, said step of creating and accumulating said learned data further including a step of adjusting the number of members included in each cluster to a predetermined number after said step of clustering extracted feature vectors.

4. The method for monitoring the condition of equipment in accordance with claim 2, said method further including a step of specifying a cluster count and a cluster-member count.

5. The method for monitoring the condition of equipment according to claim 2, said method further including a step of displaying time-series graphs representing said anomaly measure, said threshold value and determination results output from said step of determining whether a sensor signal is abnormal or normal.

6. A method for monitoring a condition of equipment, comprising the steps of:
creating learned data on the basis of sensor signals output from a plurality of sensors installed in said equipment and accumulating said learned data; and
identifying anomalies of sensor signals newly output from said sensors installed in said equipment, wherein:
said step of creating and accumulating said learned data includes the sub-steps of:
classifying operating conditions of said equipment into modes on the basis of event signals output from said equipment;
extracting feature vectors from said sensor signals;
clustering said extracted feature vectors;
accumulating the centers of clusters obtained by clustering said extracted feature vectors and feature vectors pertaining to said clusters as said learned data;
selecting one cluster or a plurality of clusters in accordance with said extracted feature vectors from said clusters accumulated as said learned data for each of said extracted feature vectors;
selecting a predetermined number of feature vectors in accordance with said extracted feature vectors from feature vectors pertaining to said selected cluster and creating a normal model by making use of said predetermined number of selected feature vectors and pertaining to said selected cluster;
computing an anomaly measure on the basis of said extracted feature vectors and said created normal model; and
computing a threshold value for each of said modes on the basis of said computed anomaly measure; and wherein:
said step of identifying anomalies of said sensor signals including the sub-steps of:
classifying operating conditions of said said equipment into modes on the basis of event signals;
extracting feature vectors from newly observed sensor signals;
selecting one cluster or a plurality of clusters in accordance with said newly observed feature vectors from said clusters accumulated as said learned data;
selecting a predetermined number of feature vectors in accordance with said newly observed feature vectors from feature vectors pertaining to said selected cluster and creating a normal model by making use of said predetermined number of selected feature vectors and pertaining to said selected cluster;
computing an anomaly measure on the basis of said newly observed feature vectors and said created normal model; and
determining whether a sensor signal is abnormal or normal on the basis of said computed anomaly measure, said mode and a threshold value computed for said mode.

7. The method for monitoring the condition of equipment according to claim 6, said method further including a step of specifying a cluster count and a cluster-member count.

8. The method for monitoring the condition of equipment according to claim 6, said method further including a step of displaying time-series graphs representing said anomaly measure, said threshold value and determination results output by said process of determining whether a sensor signal is abnormal or normal.

9. An apparatus for monitoring a condition of equipment on the basis of sensor signals output from a plurality of sensors installed in said equipment comprising:
a raw-data accumulation section configured to accumulate said sensor signals output from said sensors installed in said equipment;
a feature-vector extraction section configured to extract feature vectors from said sensor signals;
a clustering section configured to cluster said feature vectors extracted by said feature-vector extraction section;
a learned-data accumulation section configured to accumulate the centers of clusters obtained as a result of said clustering carried out by said clustering section and feature vectors pertaining to said clusters as learned data;
a cluster selection section configured to select a cluster in accordance with feature vectors from said learned data accumulated by said learned-data accumulation section;
a normal-model creation section configured to select a predetermined number of feature vectors in accordance with feature vectors extracted by said feature-vector extraction section among feature vectors pertaining to a cluster selected by said cluster selection section and create a normal model by making use of said predetermined number of selected feature vectors;
an anomaly-measure computation section configured to compute an anomaly measure on the basis of said feature vectors and said normal model;
a threshold-value setting section configured to set a threshold value on the basis of an anomaly measure computed by said anomaly-measure computation section as an anomaly measure of a feature vector included in said learned data accumulated in said learned-data accumulation section; and
an anomaly determination section configured to determine whether said condition of said equipment is abnormal or normal by making use of said anomaly measure computed by said anomaly-measure computation section and said threshold value set by said threshold-value setting section.

10. The apparatus for monitoring the condition of equipment according to claim 9 wherein said clustering section adjusts the number of feature vectors included in each cluster to a predetermined number after said clustering.

11. The apparatus for monitoring the condition of equipment according to claim 9 wherein, after said clustering has been carried out by adoption of a k averaging method, said clustering section repeatedly divides each cluster having a cluster-member count greater than a predetermined number till said cluster-member count becomes equal to or smaller than said predetermined number.

12. The apparatus for monitoring the condition of equipment according to claim 9, said apparatus further comprising a mode classification section configured to classify operating states of said equipment or operating states of said object apparatus into modes on the basis of event signals output by said equipment, wherein:
said threshold-value setting section sets a threshold value for each of said modes; and
said anomaly determination section determines whether or not an anomaly exists by making use of said threshold value set for each of said modes.

13. The apparatus for monitoring the condition of equipment according to claim 9, said apparatus further comprising a parameter input section configured to specify a cluster count and a cluster-member count.

14. The apparatus for monitoring the condition of equipment according to claim 9, said apparatus further comprising a display section configured to display time-series graphs representing said anomaly measure, said threshold value and determination results output by said anomaly determination section.
